(19) United States
(12) Patent Application Publication
(10) Pub. No.: US 2026/0352467 A1
(43) Pub. Date: Nov. 5, 2026

(54) Onboard Management Of Cryptographic Hardware Module

(71) Applicant: Arista Networks, Inc., Santa Clara, CA (US)

(72) Inventors: Japraj Singh Sandhu, Surrey (CA); Karol Kacper Brzuskiewicz, Olsztyn (PL); Karankumar Jagjitkumar, Maple Ridge (CA); Trevor Yu, Burnaby (CA)

(21) Appl. No.: 19/194,405

(22) Filed: Apr. 30, 2025

(51) Int. Cl. H04L 9/32

(52) U.S. Cl. CPC H04L 9/32

(57) ABSTRACT

A cryptographic module is a hardware component that includes cryptographic engines which perform various security functions such as encryption, decryption, key generation, storing keys and other secrets, and so on. The cryptographic module further includes firmware that is programmed on the same hardware as the cryptographic engines to operate or otherwise interact with the cryptographic engines to implement the security functions. A shared memory serves as the boundary between applications running outside the perimeter of the cryptographic module and the cryptographic module itself. Applications access the security functions via the shared memory. Using the shared memory as a boundary allows FIPS-compliant (Federal Information Standards) functionality to be implemented fully within the cryptographic module itself so that applications outside the cryptographic module can be upgraded while the cryptographic module remains FIPS compliant.

### BACKGROUND

The present disclosure is directed to FIPS (Federal Information Processing Standards) certification of cryptographic modules; e.g., MACsec engines (Media Access Control Security). FIPS certification is a process that validates the security of cryptographic modules and is required in high security deployments, such as in government agencies.

The present disclosure is directed to FIPS (Federal Information Processing Standards) certification of a cryptographic module. Disclosed embodiments describe MACsec (Media Access Control Security) engines. A MACsec engine is a cryptographic module that implements the MACsec protocol, which is a Layer 2 security standard for Ethernet networks, providing encryption, authentication, and data integrity for Ethernet traffic. Although embodiments of the present disclosure describe MACsec engines, it will be appreciated that the disclosure is applicable to computing platforms in general that employ cryptographic modules.

The cryptographic boundary is a logical perimeter that encompasses a cryptographic module comprising components including hardware (e.g., ASICs, Application Specific Integrated Circuits, FPGAs, Field Programmable Gate Arrays, etc.), firmware and/or software, and the interactions among these components to securely implement cryptographic functions such as encryption/decryption, key generation, random number generation, etc. The cryptographic boundary defines the scope of the cryptographic module's operations.

For the purposes of FIPS certification, the FIPS boundary refers to a cryptographic boundary that encompasses a cryptographic module (hardware and software/firmware) that meets FIPS compliance requirements. FIPS certification of a cryptographic module ensures that the hardware and all cryptographic operations (software/firmware) within the cryptographic boundary adhere to FIPS standards. In order for a cryptographic module to remain FIPS certified, none of the components within the cryptographic boundary can be altered and this must be ensured (i.e., verifiable) at runtime.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows an example computer platform in accordance with the present disclosure.

FIG. 2 shows an example network device in accordance with the present disclosure.

FIG. 3 illustrates example operations in a cryptographic module in accordance with the present disclosure during a power up sequence.

FIG. 4 illustrates example operations for using a cryptographic module in accordance with the present disclosure.

FIG. 5 shows a block diagram of an example network device.

### DETAILED DESCRIPTION

The present disclosure is directed to computing platforms that use cryptographic modules. For example, the present disclosure covers network devices (e.g., switches, routers, etc.) that use cryptographic modules to implement the MACsec protocol in deployments that require data security, such as in government agencies, data centers, enterprise networks, cloud computing, etc.

The present disclosure is directed to FIPS (Federal Information Processing Standards) certification of cryptographic modules. Briefly, for the purposes of the certification, a FIPS boundary defines a cryptographic module (hardware and software/firmware) that complies with FIPS standards requirements (e.g., FIPS 140-3). FIPS certification of a cryptographic module imposes requirements on the functions that must be performed by the cryptographic module, including:
1. Power-On-Self-Test (POST) of the cryptographic module: Use Known Answer Test (KAT) vectors to validate that the cryptographic module is in a good state.
2. Security parameters programming: security parameters cannot leave the cryptographic boundary unintentionally, so they need to be programmed to the ASIC from within the FIPS perimeter.
3. Zeroization of security parameters: every instance of the security parameter needs to be cleared once no longer in use.
4. Module Integrity: Integrity check of the FIPS module when it is loaded (instantiated) after a power on.
5. Versioning information: the FIPS module outputs information, representing the distinct individual hardware, software, and/or firmware components, that can be correlated with a validation record.

A FIPS-compliant cryptographic module in accordance with the present disclosure comprises cryptographic engines implemented in hardware and FIPS-compliant cryptographic module firmware (“firmware”) that is programmed on the same hardware as the cryptographic engines. In accordance with the present disclosure, the firmware is FIPS-compliant in that the firmware performs the above-listed functionality required for FIPS certification, in addition to standard cryptographic functions. In some embodiments, for example, the hardware can be an ASIC containing an embedded CPU (central processing unit). The ASIC can be designed to implement the specific functions of the cryptographic engines in order to achieve high performance; e.g., MACsec functionality. The firmware can be programmed in the ASIC and executed by the embedded CPU.

Shared memory serves as an interface between the cryptographic module and user-level applications running on a CPU (external CPU) separate from the cryptographic module. User-level applications can invoke or otherwise access the functionality of the cryptographic module via the shared memory, leaving the specific operations that implement the functionality to be performed wholly and strictly within the cryptographic module.

Cryptographic modules in accordance with the present disclosure comprise firmware that perform all FIPS-compliant functions within the cryptographic module itself. None of the operations that implement the FIPS-compliant functions are performed by software that execute on the external CPU, such as user-level applications, runtime libraries, or OS (operating system) drivers, and the like. Accordingly, user-level applications, libraries, and drivers can be upgraded without risk of decertifying the cryptographic module (and requiring a recertification process).

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

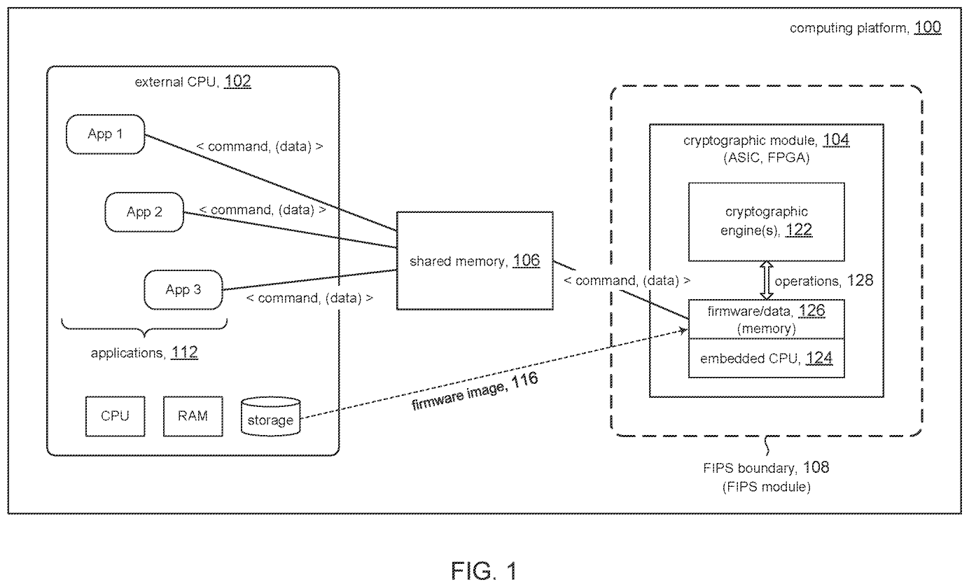

FIG. 1 is a high-level diagram of an example computing platform that embodies aspects of the present disclosure. In some embodiments, computing platform 100 comprises an external CPU 102 and cryptographic hardware 104. For discussion purposes, “external CPU” refers to components that are external to cryptographic module 104 such as a memory (e.g., RAM), storage (e.g., SRAM), and the CPU itself. A shared memory 106 serves as an interface between external CPU 102 and cryptographic hardware 104. Platform 100 comprises user-level applications 112 running on external CPU 102.

Cryptographic module 104 can be implemented on any suitable programmable hardware such as an ASIC, FPGA, and the like. Cryptographic module 104 comprises one or more cryptographic engines 122 that are programmed in the programmable hardware. The cryptographic engines 122 perform various cryptographic functions such as, but not limited to, encryption/decryption, hash computation, random number generation, checksum computation, etc. In accordance with the present disclosure, cryptographic module 104 includes an embedded CPU 124 and FIPS-compliant firmware 126 that runs on the embedded CPU. Firmware 126 initializes resources on cryptographic module 104, runs power on testing, and processes commands from shared memory. Firmware 126 performs operations 128 on one or more cryptographic engines 122 to perform various standard cryptographic functions such as encryption/decryption, key generation, random number generation, etc. Firmware 126 is FIPS-compliant in that operations 128 include performing FIPS-compliant functions required for FIPS certification, in addition to the standard cryptographic functions, and that the operations are performed only by the firmware. FIPS-compliant functions performed by firmware 126 in accordance with the present disclosure include:
1. Power-On-Self-Test (POST) of the cryptographic module: Use Known Answer Test (KAT) vectors to validate that the cryptographic module is in a good state. It is noted that the external CPU (e.g., 102) can also perform a power-on-self-test. Accordingly, the reference to POST in the present disclosure will be understood to refer to a power-on-self-test of the cryptographic module.
2. Security parameters programming: security parameters cannot leave the cryptographic boundary unintentionally, so they need to be programmed to the ASIC inside the FIPS perimeter.
3. Zeroization of security parameters: every instance of the security parameter needs to be cleared once no longer in use.
4. Module Integrity: Integrity check of the FIPS module when it is loaded (instantiated) after a power on.
5. Versioning information: the FIPS module outputs information, representing the distinct individual hardware, software, and/or firmware components, that can be correlated with a validation record.
   FIPS boundary 108 is a logical perimeter that encompasses cryptographic module 104 and FIPS-compliant functions implemented in firmware 126.

In accordance with the present disclosure, applications 112 running on external CPU 102 invoke cryptographic functionality provided by cryptographic module 104 via shared memory 106. An application (e.g., App 1) invokes functionality in cryptographic module 104 by writing information to shared memory 106. For example, the information can include a command that indicates the cryptographic function of interest and any data associated with the function. Firmware 126 running on the embedded CPU 124 can read out the information stored in shared memory 106 and perform operations 128 on cryptographic engines 122 to implement the cryptographic function of interest. If the function includes returning information to the application, the firmware 126 can write such information to shared memory 106 where the application 112 can read out that information.

The functionality that can be invoked by applications 112 include FIPS-compliant functions such as programming security parameters and zeroization. More specifically, the applications 112 send commands to cryptographic module 104, for example, via shared memory 106 as described above. Firmware 126 in cryptographic module 104 invokes specific operations on cryptographic engines 122 to perform the specified commands wholly within the FIPS boundary 108. Stated differently, the operations performed on cryptographic engines 122 are performed only by firmware 126 and not by any software outside of the FIPS boundary.

In accordance with the present disclosure, a storage component of external CPU 102 can store firmware image 116 comprising executable code including the cryptographic module firmware itself and data used by or otherwise associated with the executable code. Firmware 126 and the data used by the firmware can be installed from firmware image 116 by loading the firmware image into embedded CPU 124 (e.g., a memory of the embedded CPU). This aspect of the present disclosure is discussed further below.

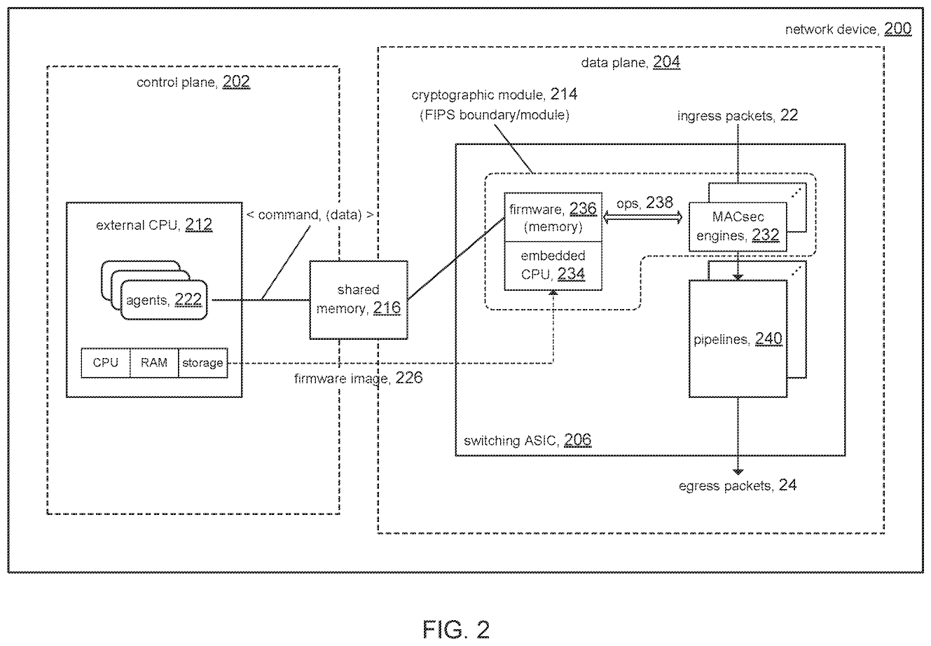

FIG. 2 is an illustrative example of the computing device of FIG. 1 in the context of a network device, such as a switch, a router, a wireless access point, and so on. Network device 200 generally comprises control plane 202 and data plane 204. Control plane 202 provides various traffic management functions such as, but not limited to, routing, security, load balancing, analysis, and the like. Control plane 202 comprises agents 222 that run on external CPU 212 to provide the foregoing traffic management functions.

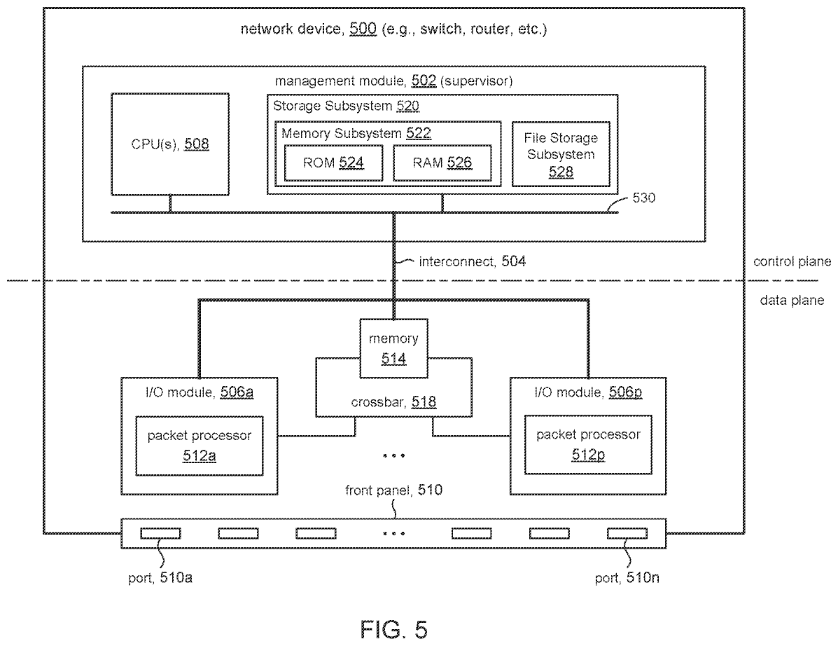

Data plane 204 receives, processes, and forwards packets (ingress packets 22) that constitute the data flow to network device 200. Data plane 204 comprises one or more switching ASICs 206 (e.g., packet processors 512, FIG. 5). Each switching ASIC 206 comprises one or more packet processing pipeline 240 to process ingress packets 22 for egress (egress packets 24). In some embodiments where data security is required, switching ASIC 206 can be configured with MACsec engines 232 to encrypt/decrypt traffic through pipelines 240. Briefly, ingress packets 22 first enter a MACsec engine 232 to be processed (e.g., encrypted or decrypted) and then continue on to a pipeline 240 to be processed for egress. As illustrated in FIG. 2, switching ASIC 206 can have multiple MACsec engines 232 and multiple pipelines 240. In a given embodiment, each pipeline can have a single corresponding MACsec engine. In other embodiments, there can be multiple MACsec engines per pipeline, and in still other embodiments, there can be one MACsec engine per multiple pipelines.

In accordance with the present disclosure, switching ASIC 206 can be configured with an embedded CPU 234 to run firmware 236. Firmware 236 can perform operations 238 on MACsec engines 232 to implement the above-described functions, namely POST, programming, zeroization, and integrity checking. The MACsec engines 232, embedded CPU 234, and firmware 236 constitute a cryptographic module 214. The cryptographic module 214 is FIPS-compliant in that the functions implemented by firmware 236 are performed wholly within the bounds of the cryptographic module. Stated differently, all of the operations 238 on MACsec engines 232 that implement the above-described functions are performed wholly within the FIPS boundary of cryptographic module 214. It will be appreciated that in various embodiments, cryptographic module 214 is implemented on the same ASIC as the rest of the switching logic, and although the switching ASIC itself is the physical device that is submitted for FIPS compliance testing, only the functionality of the cryptographic module is subject to FIPS testing and not the non-cryptographic functions.

In accordance with the present disclosure, a storage component of external CPU 212 can store firmware image 226 comprising executable code and data used by or otherwise associated with the executable code. Firmware 236 and the data used by the firmware can be installed in cryptographic module 214 by loading firmware image 226, stored on external CPU 212, into embedded CPU 234 (e.g., a memory of the embedded CPU). This aspect of the present disclosure is discussed further below.

Shared memory 216 serves as an interface between agents 222 running in the control plane 202 and MACsec engines 232 in the data plane 204.

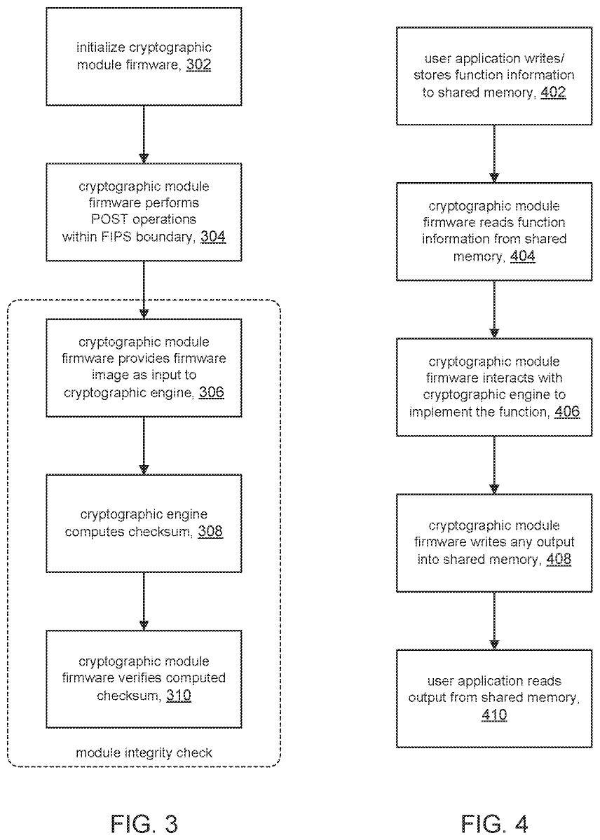

Referring to FIG. 3, the discussion will now turn to a high-level description of power-on operations and processing in a cryptographic module (e.g., 104, FIGS. 1, 214, FIG. 2) performed by cryptographic module firmware (e.g., firmware 126, 236) operating within a FIPS boundary (e.g., 108, 214) in accordance with the present disclosure. The operations will be described in the context of a network device (e.g., FIG. 2), with the understanding that the operations can be adapted to any computing platform configured to operate with a cryptographic module.

At operation 302, the cryptographic module firmware can be initialized. At some point during operation of the network device, the network device (e.g., external CPU 212) can initialize the embedded CPU (e.g., 234). For example, the cryptographic module firmware can be initialized when the network device is powered up, power cycled, or reset. The cryptographic module firmware can be initialized by loading an image (e.g., 226) of the cryptographic module firmware into a memory of the embedded CPU. Referring to FIG. 2, for instance, in some embodiments “loading” involves copying firmware image 226 stored in external CPU 212 into the memory of embedded CPU 234, and then triggering the embedded CPU to start running the loaded firmware. Firmware image 226 can comprise code and data including the cryptographic module firmware itself and the data (e.g., known answer test vectors) that is used during the power-on self test, discussed below.

At operation 304, the cryptographic module firmware can include code to perform an initial power-on self test (POST) of the cryptographic module when the firmware starts running. In accordance with the present disclosure, POST processing of the cryptographic module runs unconditionally. POST processing includes using known answer test (KAT) vectors to verify the cryptographic engines operate as expected. KAT vectors comprise vectors of inputs and expected outputs. In some embodiments, for example, the cryptographic module firmware includes vector processing code that applies the inputs of a given test vector to the cryptographic engines, and compares the outputs of the cryptographic engines (e.g., hash values, encrypted text, clear text, etc.) to the expected outputs of the given test vector. The vector processing code repeats this for each test vector. Differences can be flagged; for example, by storing the outcomes in shared memory (e.g., 106, 216) to inform applications that execute outside of the FIPS boundary. If the initial FIPS POST execution succeeds, then processing can continue; otherwise, the firmware can throw an error and take suitable action (the details of which are not relevant to the present disclosure).

In accordance with the present disclosure, all operations that constitute the power-on self test are performed entirely within the FIPS boundary. In other words, none of the operations originate from outside the FIPS boundary and no input data comes in from outside the FIPS boundary. For example, the cryptographic module firmware, which performs the POST, runs on the embedded CPU, and so all POST-related operations are performed within the FIPS boundary. Likewise, all the KAT vectors are stored in the memory of the embedded CPU and read from the memory during the power-on self test.

At operation 306, the cryptographic module firmware can initiate a module integrity check to verify the cryptographic module. In some embodiments, the integrity check comprises verifying the firmware and its associated data stored in the embedded CPU. In accordance with the present disclosure, the cryptographic module firmware can read out the firmware image as it is stored in the embedded CPU memory, namely the firmware itself and associated data, and provide the stored image to the cryptographic engines. In some embodiments, for example, the stored image (code and data) can be treated as a KAT input vector that is input to the vector processing code of the cryptographic module firmware.

At operation 308, the cryptographic engine can compute a checksum from the stored image provided by the cryptographic module firmware.

At operation 310, the cryptographic module firmware can compare the computed checksum against a checksum that is hardcoded in the cryptographic module firmware to assess the integrity and authenticity of the firmware. For example, the checksum can be stored as part of the image that is stored in the embedded CPU. If the computed checksum does not match the hardcoded checksum, the mismatch can be flagged and the firmware can throw an error and take suitable action (the details of which are not relevant to the present disclosure).

Referring to FIG. 4, the discussion will now turn to a high-level description of processing in a computing platform to service cryptographic functionality invoked by user-space applications in accordance with the present disclosure. For discussion purposes, the example use case for a computing platform will be a network device (e.g., 200, FIG. 2), with the understanding that the processing described below is applicable to any computing platform configured to operate with a cryptographic module.

At operation 402, a user application that wants to invoke a cryptographic function can write information into shared memory (e.g., 216) comprising, for example, a command indicating the function of interest and input data (if any) that is associated with the function. For a network device use case, for example, the user application can be an agent (e.g., 222) running in the control plane (e.g., 202) of the network device. Illustrative examples of cryptographic functions include:
programming security parameter in the cryptographic module (e.g., 214)—As noted above, FIPS compliance requires that security parameters cannot leave the FIPS boundary unintentionally. While security parameters may be obtained outside of the FIPS boundary, the operations for programming those security parameters must be performed inside the FIPS boundary in order to be in compliance with FIPS. For example, an agent executing in one network device can communicate with another network device to negotiate keys for the MACsec protocol; this communication takes place outside of the FIPS boundary. The network device can then send command(s) via the shared memory (e.g., 216) to program those keys in the cryptographic engines so they can be used to encrypt/decrypt traffic; the programming occurs within the FIPS boundary.
zeroization (deprogramming) of one or more security parameters—Every instance of the specified security parameter(s) in the cryptographic engines needs to be cleared once they are no longer in use. The operations for zeroing out security parameters in the cryptographic module must be performed inside the FIPS boundary in order for the operation to be deemed FIPS-compliant.
For example, the network device can request to zero out one or more security parameters previously programmed in the cryptographic module; for example, in response to user input or due to the network device aging out the security parameters. In accordance with the present disclosure, the network device can store function information to shared memory that includes a command for the zeroing out function and input data for the function that specifies one or more security parameters to zero out.

At operation 404, the cryptographic module firmware (e.g., 236), executing within the FIPS boundary, can read function information stored in the shared memory. In the case of the “programming” example above, the function information comprises a code (e.g., a numerical value) that corresponds to the programming function, and the input data is the security parameter (e.g., cryptographic key) to be programmed. For the “deprogramming” example, the function information comprises a code that corresponds to the deprogramming function, and the input data is the security parameter(s) to be zeroed out.

At operation 406, the cryptographic module firmware can perform operations on the cryptographic engines to implement the desired functions by issuing one or more operations to the cryptographic engines. In the “programming” example, for instance, the cryptographic module firmware can operate on one or more of the cryptographic engines to program the security parameter into the cryptographic engines. For the “deprogramming” example, the cryptographic module firmware can perform operations to clear user-provided secrets from one or more of the cryptographic engines. Notably, in accordance with the present disclosure, the operations are performed only by the cryptographic module firmware.

At operation 408 the cryptographic module firmware can store information relating to performing the cryptographic function into the shared memory. The information indicates success or failure of the function, the information can include any results from performing the function, and so on.

At operation 410, the user application can read the shared memory to access any information that may be generated from the cryptographic function and take appropriate action. Processing can be deemed complete.

The cryptographic module firmware performs all the operations on the cryptographic engines within the FIPS boundary to implement the cryptographic functions. None of the operations on the cryptographic engines are performed in userspace. Because the cryptographic module firmware is wholly within the module that is FIPS certified, user-level applications and the OS can be freely updated without risk of decertifying the FIPS module.

FIG. 5 is a block diagram representation of an example network device 500 (e.g., a router, switch, firewall, and the like) that can be adapted in accordance with the present disclosure. In some embodiments, for example, network device 500 can include one or more management modules 502, one or more I/O modules (switches, switch chips) 506a-506p, and a front panel 510 of I/O ports (physical interfaces, I/Fs) 510a-510n. Management module 502 can constitute the control plane of network device 500 (also referred to as the control layer or simply the central processing unit, CPU), and can include CPU(s) 508 for managing and controlling operation of network device 500 in accordance with the present disclosure. CPU(s) 508 can be a general-purpose processor, such as an Intel®/AMD® x86, ARM® microprocessor and the like, that operates under the control of software stored in a memory device/chips such as read-only memory (ROM) 524 or random-access memory (RAM) 526. The control plane provides services that include traffic management functions such as routing, security, load balancing, analysis, and the like.

CPU(s) 508 can communicate with storage subsystem 520 via bus subsystem 530. Other subsystems, such as a network interface subsystem (not shown in FIG. 5), may be on bus subsystem 530. Storage subsystem 520 can include memory subsystem 522 and file/disk storage subsystem 528. Memory subsystem 522 and file/disk storage subsystem 528 represent examples of non-transitory computer-readable storage devices that can store program code and/or data, which when executed by CPU(s) 508, can cause CPU(s) 508 to perform operations in accordance with embodiments of the present disclosure.

Memory subsystem 522 can include a number of memories such as main RAM 526 (e.g., static RAM, dynamic RAM, etc.) for storage of instructions and data during program execution, and ROM (read-only memory) 524 on which fixed instructions and data can be stored. File storage subsystem 528 can provide persistent (i.e., non-volatile) storage for program and data files, and can include storage technologies such as solid-state drive and/or other types of storage media known in the art.

CPU(s) 508 can run a network operating system stored in storage subsystem 520. A network operating system is a specialized operating system for network device 500. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 530 can provide a mechanism for the various components and subsystems of management module 502 to communicate with each other as intended. Although bus subsystem 530 is shown schematically as a single bus, alternative embodiments of the bus subsystem can utilize multiple buses.

The one or more I/O modules 506a-506p can be collectively referred to as the data plane of network device 500 (also referred to as the data layer, forwarding plane, etc.). Interconnect 504 represents interconnections between modules in the control plane and modules in the data plane. Interconnect 504 can be any suitable bus architecture such as Peripheral Component Interconnect Express (PCIe), System Management Bus (SMBus), Inter-Integrated Circuit (I2C), etc.

I/O modules 506a-506p can include respective packet processing hardware comprising packet processors 512a-512p (collectively 512) to provide packet processing and forwarding capability. Each I/O module 506a-506p can be further configured to communicate over one or more ports 510a-510n on the front panel 510 to receive and forward network traffic. Packet processors 512 can comprise hardware (circuitry), including for example, data processing hardware such as an application specific integrated circuit (ASIC) which can include an embedded CPU, field programmable gate array (FPGA), processing unit, and the like, which can be configured to operate in accordance with the present disclosure. Packet processors 512 can include forwarding lookup hardware such as, for example, but not limited to content addressable memory such as ternary CAMs (TCAMs) and auxiliary memory such as static RAM (SRAM).

Memory hardware 514 can include buffers used for queueing packets and shared memory (e.g., 216). I/O modules 506a-506p can access memory hardware 514 via crossbar 518. It is noted that in other embodiments, the memory hardware 514 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method for operating a cryptographic module in a computing platform in accordance with Federal Information Processing Standards (FIPS), the method comprising:
the cryptographic module performing a self test of the cryptographic module, as part of a power up sequence of the computing platform to verify the cryptographic module, by executing first computer executable instructions that are programmed in a first memory in the cryptographic module, wherein execution of the first computer executable instructions causes the self test of the cryptographic module to be performed;
the computing platform providing security parameters to the cryptographic module by executing second computer executable instructions that are programmed in a second memory separate from and external to the cryptographic module, wherein execution of the second computer executable instructions causes the security parameters to be stored in a third memory separate from and external to the cryptographic module;
the cryptographic module detecting that the security parameters are stored in the third memory; and
in response to the cryptographic module detecting that the security parameters are stored in the third memory, the cryptographic module programming the security parameters into one or more cryptographic engines in the cryptographic module by executing third computer executable instructions that are programmed in the first memory in the cryptographic module, wherein execution of the third computer executable instructions causes the security parameters to be read out from the third memory and programmed into the one or more cryptographic engines in the cryptographic module.

2. The method of claim 1, wherein the self test of the cryptographic module includes the cryptographic module performing a FIPS power-on self-test using known answer test vectors.

3. The method of claim 1, wherein the self test of the cryptographic module includes the cryptographic module performing a module integrity check of a firmware image that constitutes the cryptographic module.

4. The method of claim 3, the module integrity check includes the cryptographic module providing the firmware image as input data to the cryptographic engine, wherein the cryptographic engine generates a value based on the input data, wherein the generated value is used to verify integrity and authenticity of the cryptographic module.

5. The method of claim 1, further comprising:
the computing platform zeroing-out security parameters in the cryptographic module by executing fourth computer executable instructions that are programmed in the second memory that is separate from and external to the cryptographic module, wherein execution of the fourth computer executable instructions causes data indicative of a zero-out operation to be stored in the third memory that is separate from and external to the cryptographic module;
the cryptographic module detecting that data indicative of the zero-out operation is stored in the third memory; and
in response to the cryptographic module detecting that data indicative of the zero-out operation is stored in the third memory, the cryptographic module zeroing out the security parameters in the one or more cryptographic engines in the cryptographic module by executing fifth computer executable instructions that are programmed in the first memory in the cryptographic module, wherein execution of the fifth computer executable instructions clears the security parameters in the one or more cryptographic engines.

6. The method of claim 5, further comprising the cryptographic module monitoring the third memory to detect that data indicative of the zero-out operation has been stored in the third memory.

7. The method of claim 1, further comprising the cryptographic module storing state information relating to operation of the cryptographic module in the third memory that is separate from and external to the cryptographic module, wherein the computing platform performs actions based on the state information stored in the third memory.

8. The method of claim 1, wherein the executable instructions in the first memory are executed by a first central processing unit (CPU) in the cryptographic module, wherein the executable instructions in the second memory are executed by a second CPU separate from the first CPU and external to the cryptographic module.

9. The method of claim 1, wherein the computing platform is a network device.

10. A network device comprising:
one or more computer processors;
a cryptographic module separate from the one or more computer processors, the cryptographic module comprising one or more cryptographic engines and cryptographic module firmware;
a first memory separate from the cryptographic module that is accessible by the one or more computer processors and not accessible by the cryptographic module;
a second memory separate from the cryptographic module that is accessible by the one or more computer processors and by the cryptographic module; and
computer executable instructions stored in the first memory for controlling the one or more computer processors to store a function code in the second memory associated with a cryptographic function,
wherein the cryptographic module firmware:
reads out the function code stored in the second memory; and
performs one or more operations on one or more of the cryptographic engines in the cryptographic module to implement the cryptographic function associated with the function code,
wherein all of the one or more operations are performed only by the cryptographic module firmware and not by any of the computer executable instructions stored in the first memory.

11. The network device of claim 10, wherein the cryptographic module firmware performs a power on self test as part of a power up sequence of the network device, wherein the power on self test is performed only by the cryptographic module firmware.

12. The network device of claim 11, wherein the power on self test includes a module integrity check, wherein the cryptographic module firmware provide a firmware image of the cryptographic module as an input to the cryptographic engine to compute a value from the firmware image, where the computed value is used to verify integrity and authenticity of the cryptographic module.

13. The network device of claim 10, wherein the computer executable instructions further control the one or more computer processors to:
receive a security parameter from a user; and
store a “program” function code and the received security parameter in the second memory,
wherein the cryptographic module firmware programs the security parameter in cryptographic engines of the cryptographic module in response to reading out the “program” function code from the second memory.

14. The network device of claim 10, wherein the computer executable instructions further control the one or more computer processors to store a “zero out” function code and one or more security parameters in the second memory, wherein the cryptographic module firmware zeros out the one or more security parameters stored in the cryptographic engines of the cryptographic module in response to reading out the “zero out” function code from the second memory.

15. The network device of claim 10, wherein the cryptographic module is a MACsec engine.

16. A method in a computing platform, the method comprising:
a CPU (central processing unit) of the computing platform storing a function code and input data associated with the function code in a memory that is shared by the CPU and by a cryptographic module of the computing platform that is separate from the CPU;
cryptographic module firmware in the cryptographic module reading out the function code and the input data; and
the cryptographic module firmware performing one or more operations on one or more cryptographic engines in the cryptographic module to implement a cryptographic function associated with the function code, wherein all of the one or more operations are performed only by the cryptographic module firmware and not by the CPU.

17. The method of claim 16, further comprising the cryptographic module firmware performing a power on self test as part of a power up sequence of the network device, wherein the power on self test is performed only by the cryptographic module firmware, wherein the power on self test includes a module integrity check, the method further comprising the cryptographic module firmware providing a firmware image of the cryptographic module as an input to the cryptographic engine to compute a value from the firmware image, where the computed value is used to verify integrity and authenticity of the cryptographic module.

18. The method of claim 16, further comprising:
the CPU receiving a security parameter from a user and storing a “program” function code and the received security parameter in the shared memory; and
the cryptographic module firmware programming the security parameter in cryptographic engines of the cryptographic module in response to the “program” function code being stored in the shared memory, wherein operations for programming the security parameter in cryptographic engines are performed entirely by the cryptographic module firmware.

19. The method of claim 16 further comprising:
the CPU storing a “zero out” function code and the received security parameter in the shared memory; and
the cryptographic module firmware zeroing out the one or more security parameters stored in the cryptographic engines of the cryptographic module in response to the “zero out” function code being stored in the shared memory, wherein operations for zeroing out the security parameter in cryptographic engines are performed entirely by the cryptographic module firmware.

20. The method of claim 16, wherein the computing platform is a network device and the cryptographic engine is a MACsec encryption engine.
